(19) United States
(12) Patent Application Publication
(10) Pub. No.: US 2008/0079804 A1
(43) Pub. Date: Apr. 3, 2008

(54) DISPLAY DEVICE, IMAGE PROCESSING METHOD, AND ELECTRONIC APPARATUS

(75) Inventors: Goro HAMAGISHI, Toyonaka City (JP); Nobuo SUGIYAMA, Suwa-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/864,610

(22) Filed: Sep. 28, 2007

(30) Foreign Application Priority Data
Sep. 29, 2006 (JP) 2006-268984
Jan. 11, 2007 (JP) 2007-003235

(51) Int. Cl. H04N 13/04

(52) U.S. Cl. 348/51; 348/E13.075

(57) ABSTRACT

A display device for displaying a plurality of images comprising pixels including a plurality of subpixels of different colors, a display unit capable of arranging the pixels in the horizontal and vertical direction, an image data combining circuit capable of combining image data for a first and second image to be displayed on the display unit; and an image separation member capable of spatially separating the first and second image displayed on the display unit, wherein the first image comprises display pixels including one or more subpixels selected from the plurality of subpixels included in one pixel of the first image, and the second image comprises display pixels including one or more subpixels other than the subpixels selected for the first image.

### BACKGROUND

The entire disclosure of Japanese Patent Application No. 2006-268984, filed Sep. 29, 2006 and Japanese Patent Application No. 2007-003235, filed Jan. 11, 2007 are expressly incorporated herein by reference.

1. Technical Field

The present invention relates to a device capable of displaying a stereoscopic image. More specifically, the present invention relates to a display device, image processing method, and electronic apparatus, capable of displaying a stereoscopic image or a multi-viewpoint image without requiring specialized glasses.

2. Related Art

Methods for displaying a stereoscopic image without requiring special glasses are known, including the parallax barrier method and lenticular method. In each method, an image for the left eye (left-eye image) and an image for the right eye (right-eye image) are alternately displayed on a screen in vertical stripes. The displayed images are separated using a parallax barrier or a lenticular lens and are then shown individually to the left and right eyes of an observer, creating a stereoscopic image (hereinafter referred to as the “stripe barrier method”).

FIG. 11 shows a schematic construction of a display device which uses a parallax barrier. The screen W includes a left-eye image L and a right-eye image R, which are displayed on an alternating column-by-column basis. Between the screen W and the observer H is disposed a parallax barrier B, which is one example of an image separation member capable of spatially separating the left-eye image L and the right-eye image R. The parallax barrier B is a light blocking film having a plurality of apertures which correspond to the left-eye image L and the right-eye image R. The parallax barrier B prevents the left-eye image L from being displayed to the right eye of the observer H and preventing the right-eye image R from being displayed to the left eye of the observer H. The parallax barrier B is provided with slits S arranged into vertical stripes. With the slits S, the left-eye image L can be displayed to the left eye of the observer H, and the right-eye image R can be displayed to the right eye of the observer H.

FIGS. 12A-12C are explanatory diagrams showing a method for combining the left-eye image L and the right-eye image R onto one screen W. FIG. 12A shows image data DL′ for the left eye (left-eye image data) and image data DR′ for the right eye (right-eye image data) which are supplied to the display device. FIG. 12B shows left-eye image data DL and right-eye image data DR obtained by compressing the left- and right-eye image data DL′ and DR′ in the horizontal direction, and FIG. 12C shows combined image data D obtained by alternately rearranging the image data DR and DL on an column-by-column basis and combining the rearranged image data.

As shown in FIGS. 12A-C, by combining the two images L and R on one screen W, the horizontal resolution of the images L and R are reduced by 50%. The left-eye image data DL′ and the right-eye image data DR′ supplied to the display device are filtered out by an image data combining circuit on a pixel-by-pixel basis and are processed into the left-eye image data DL and the right-eye image data DR, causing the horizontal resolution to be reduced by 50 percent. The image data DL and DR are rearranged on an alternating subpixel basis and combined, producing the combined data D, such as the process disclosed in Japanese Patent Application No. JP-A-2000-244946.

FIGS. 13A to 13C show plan views of a portion of an image of the combined data D displayed on the screen W. In the drawing, FIG. 13A shows a combined image of the left-eye image L and the right-eye image R, FIG. 13B shows the right-eye image R as observed through the parallax barrier B, and FIG. 13C shows the left-eye image L as observed through the parallax barrier B. In the drawing, the characters “r,” “g” and “b” respectively represent subpixels associated with color filters of red, green, and blue.

As shown in FIG. 13A, the subpixels for displaying the right-eye image R and the subpixels for displaying the left-eye image L are arranged so as to alternate in the horizontal direction. In the vertical direction the plurality of subpixels for displaying the right-eye image R and a plurality of subpixels for displaying the left-eye image L are arranged so as to form alternate columns of subpixels. Additionally, the plurality of subpixels for displaying images R and L are arranged so as to correspond to the direction of arrangement the color filters, forming stripes. The right-eye image R and the left-eye image L shown in FIG. 11 each represent an image formed by the subpixels, corresponding to one column arranged in the vertical direction.

FIG. 13B shows a set of three subpixels represented by the coordinates (n, k), which constitute one display pixel PR for the right-eye image R. That is, the display pixel PR is composed of three (red, blue, and green) subpixels. The display pixel PR is a minimum display unit which is used for displaying a post-combined right-eye image R, and is different from a pixel (panel pixel) of the screen W. That is, the display pixel PR is different from the pixel composed of a set of three (red, green, and blue) subpixels that are adjacent in the horizontal direction. On the screen W, a plurality of display pixels PR for the right eye (right-eye display pixel) are arranged in the horizontal and vertical directions. The plurality of right-eye display pixels PR form the whole right-eye image R.

In FIG. 13C, a set of three subpixels represented by the coordinates (n, k) constitute one display pixel PR for the left-eye image L. The display pixel PL is composed of three subpixels of red, blue. The display pixel PL is the minimum display unit for displaying a post-combined left-eye image L, and is different from the pixel (panel pixel) of the screen W. That is, the display pixel PL is different from a set of three (red, green, and blue) adjacent subpixels in the horizontal direction. A plurality of display pixels PL for the left eye (left-eye display pixel) are arranged in the horizontal and vertical directions on the screen W. The plurality of left-eye display pixels PL form the whole left-eye image L.

However, since the display pixels PR and PL are composed of three subpixels which are alternately arranged on a subpixel-by-subpixel basis, the size of the display pixels PR and PL is doubled in the horizontal direction compared with that required for displaying a two-dimensional image, making it difficult to sufficiently display a fine image. For example, FIGS. 14A and 14B illustrate the difficulties that arise when a white bright line SW is displayed on the screen W. As shown in FIG. 14A, when a bright line SW is displayed on the right-eye image R, it is necessary to illuminate the display pixels PR which are overlapped by the bright line SW (FIG. 14B). Since the size of the display pixels PR is twice the size required for displaying the two-dimensional image in the horizontal direction, the width of the bright line SW is also increased in the horizontal direction, causing the shape of the bright line SW to be greatly deformed.

One method for solving the problem is an oblique barrier method (step barrier method) in which the right-eye image R and the left-eye image L are arranged so as to alternate in both the horizontal and vertical direction, while the parallax barrier B is arranged so as to correspond to the images R and L. Using this method, the aspect ratio of the display pixel approaches 1:1, meaning that the resulting image is not greatly deformed, making it is possible to obtain a smooth image.

Despite these advantages, however, the improvement of image quality is still limited, since the size of one display pixel is twice that of the original pixel (panel pixel), making it difficult to obtain sufficient resolution to display a fine image. Thus a method and system is needed for improving the quality of a stereoscopic image.

### BRIEF SUMMARY OF THE INVENTION

An advantage of some aspects of the invention is that it provides a display device and an image processing method capable of displaying a stereoscopic image or a multi-viewpoint image at a high resolution. Another advantage of some aspects of the invention is that it provides an electronic apparatus with a display device capable of displaying a stereoscopic image or a multi-viewpoint image with a clear and smooth border.

One aspect of the invention is a display device comprising pixels including a plurality of subpixels of different colors, a display unit capable of arranging the pixels in horizontal and vertical directions; an image data combining circuit capable of combining image data for a first image and second image to be displayed on the display unit; and an image separation member capable of spatially separating the display the first and second image on the display unit, wherein the first image includes a display pixel comprised of one or more subpixels selected from the plurality of subpixels included in one pixel, and the second image includes a display pixel comprising one or more subpixels which are other than the one or more subpixels selected for the first image. According to such a configuration, since the image data for the first and second images are compressed by being filtered out on the subpixel level, the size of the display pixels for displaying a combined image of the first and second images becomes equal to that of the pixels (panel pixels) used to display the two-dimensional image. Thus, it is possible to display an image at a high resolution.

Another aspect of the invention is an image processing method wherein a first image and a second image are combined and displayed on one screen. The method comprises constructing a plurality of display pixels from one or more subpixels selected from a plurality of subpixels included in one pixel of the first image, and constructing a plurality of display pixels from one or more subpixels of the second image which are different than subpixels selected for the first image. According to such a method, since the image data for the first and second images are compressed by being filtered out on the subpixel level, the size of the display pixels used to display the combined image of the first and second images is equal to the size required for displaying the two-dimensional image. Thus, it is possible to display an image at a high resolution.

Another aspect of the invention is a electronic apparatus having the display device described. According to such a configuration, it is possible to provide an electronic apparatus capable of displaying a stereoscopic image or a multi-viewpoint image with a clear and smooth border.

### BRIEF DESCRIPTION OF THE DRAWINGS

The invention will be described with reference to the accompanying drawings, wherein like numbers reference like elements.

FIG. 1 is a schematic diagram showing the construction of a display device in accordance with a first embodiment of the invention;

FIG. 2 is a block diagram showing the construction of the display device;

FIG. 3 is a block diagram showing the electrical construction of a display unit and a peripheral driving circuit of the display device;

FIG. 4 is a diagram for explaining an image processing method of the display device;

FIGS. 5A to 5C are plan views of a combined image which is combined using the image processing method;

FIGS. 6A and 6B are diagrams for explaining the advantages of the display device;

FIG. 7 is a plan view of a parallax barrier of the display device;

FIG. 8 is a block diagram showing the construction of a display device in accordance with a second embodiment of the invention;

FIG. 9 is a block diagram showing the electrical construction of a display unit and a peripheral driving circuit of the display device;

FIG. 10 is a schematic diagram showing a cellular phone as an example of an electronic apparatus capable of performing the invention;

FIG. 11 is a schematic diagram showing the construction of a known display device;

FIG. 12 is a diagram for explaining an image processing method of the display device;

FIGS. 13A to 13C are plan views of a combined image combined using the image processing method; and

FIGS. 14A and 14B are diagrams for explaining the advantages of the display device.

### DESCRIPTION OF EXEMPLARY EMBODIMENTS

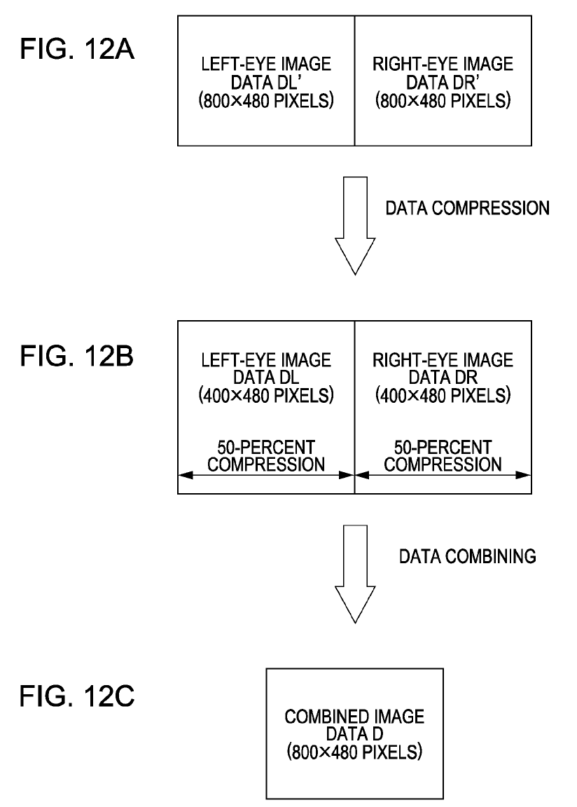

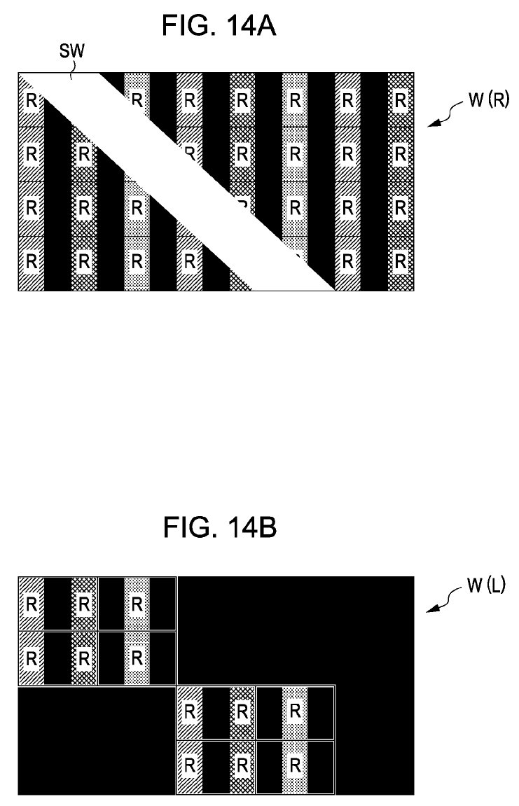

Hereinafter, exemplary embodiments of the invention will be described in detail with reference to the accompanying drawings. In the following descriptions, the columnar direction of a screen (the arrangement direction of data lines) will be referred to as “vertical direction,” and the row direction in the screen (the arrangement direction of scanning lines) will be referred to as “horizontal direction.” The same constituent elements as those of the known display device shown in FIGS. 11 to 14 will be referenced by the same reference numerals, and the detailed descriptions thereof will be omitted.

### First Embodiment

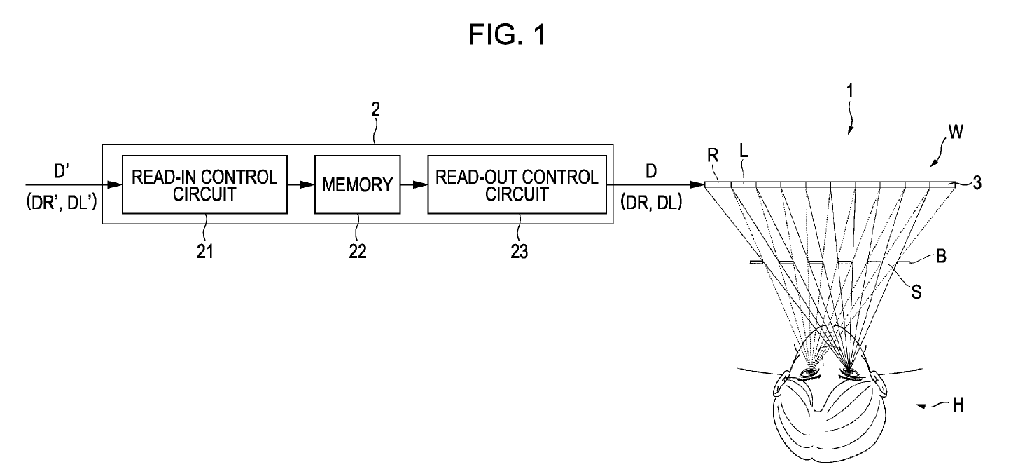

FIG. 1 is a schematic diagram showing the construction of a display device 1 of a first embodiment of the invention. The display device 1 includes an image data combining circuit 2 that combines multiple image data D′, which includes a plurality of image data DR′ and DL′, into image data D for displaying on one screen. The display device 1 also includes a display panel which displays the image data D supplied from the image data combining circuit 2 to the screen W and a parallax barrier (image separation member) B that spatially separates the plurality of images R and L displayed on the screen W so as to be block the view to the left eye and the right eye of the observer H, respectively.

The multiple image data D′ includes the right-eye image data DR′ and the left-eye image data DL′. The right-eye image data DR′ and the left-eye image data DL′ each include image data which corresponds to a screen. The right-eye image data DR′ is allocated to the upper half portion of a data area, and the left-eye image data DL′ is allocated to the lower half portion of the data area. This way, the multiple image data D′ is produced which include the image data corresponding to a plurality of screens.

The image data combining circuit 2 includes a read-in control circuit 21 that compresses the multiple image data D′ and sequentially stores the compressed image data in the memory 22. The image data combining circuit 2 also includes a read-out control circuit 23 which reads out the image data stored in the memory 22 in accordance with a predetermined rule and outputs the image data as the image data D corresponding to one screen. The image data combining circuit 2 filters out portions of the right-eye image data DR′ and the left-eye image data DL′ included in the multiple image data D′ using the read-in control circuit 21, and alternately rearranges the image data DR′ and DL′ using the memory 22, thereby combining new image data D.

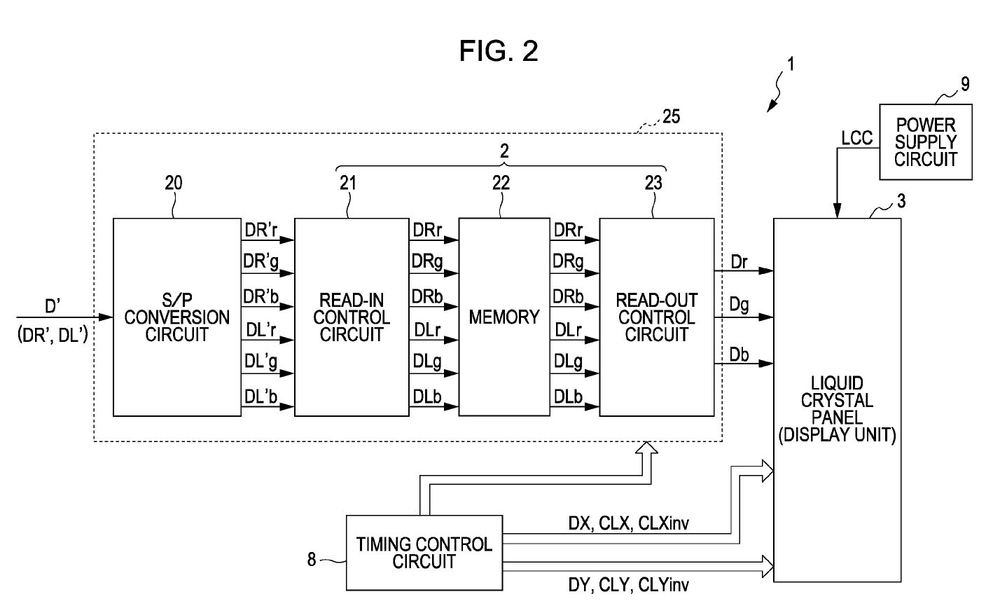

FIG. 2 is a block diagram showing the construction of the display device 1. The display device 1 includes a liquid crystal panel 3 which serves as the display unit, an image data supply circuit 25, a timing control circuit 8, and a power supply circuit 9.

The timing control circuit 8 is provided with a timing signal generating unit (not shown) that generates dot clocks for scanning pixels (panel pixels) of the liquid crystal panel 3. Based on the dot clocks generated by the timing signal generating unit, the timing control circuit 8 generates a Y clock signal CLY, an inverted Y clock signal CLYinv, a X clock signal CLX, an inverted X clock signal CLXinv, a Y start pulse DY, and a X start pulse DX, and supplies the generated signals and pulses to the image data supply circuit 25 and the liquid crystal panel 3.

The image data supply circuit 25 includes an S/P conversion circuit 20, a read-in control circuit 21, memory 22, and a read-out control circuit 23. The S/P conversion circuit 20 divides a chain of serially supplied multiple image data D′ from an external source into image data components DR′r, DR′g and DR′b for the right-eye image and image data components DL′r, DL′g and DL′b, and outputs the image data components as six-phase-developed image data. The read-in control circuit 21 filters out portions of six image data components DR′r, DR′g, DR′b, DL′r, DL′g and DL′b that were phase-developed by the S/P conversion circuit 20 in order to produce six new image data components DRr, DRg, DRb, DLr, DLg and DLb, and supplies the new image data components to the memory 22. The read-out control circuit 23 rearranges the image data components DRr, DRg, DRb, DLr, DLg and DLb stored in the memory 22, and outputs image data components Dr, Dg, and Db for the combined image. Image data components designated by “r,” “g” and “b” are image data components of red, green, and blue, respectively. The image data components Dr, Dg, and Db respectively are image data components of red, green, and blue for the combined image of the right-eye image and the left-eye image.

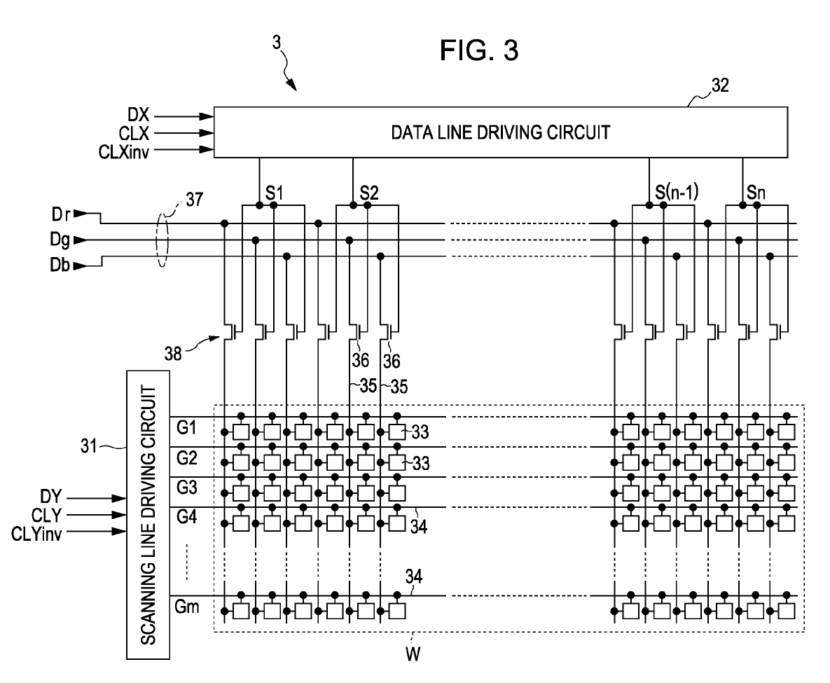

FIG. 3 is a block diagram showing the electrical construction of the liquid crystal panel 3 and a peripheral driving circuit of the display device 1. The liquid crystal panel 3 is provided with an image display area (screen) W for displaying the image data components Dr, Dg, and Db. In the image display area W, a plurality of pixel electrodes 33 are aligned in a matrix in the horizontal and vertical directions. In the borders of the pixel electrodes 33, a plurality of scanning lines 34 are arranged in the horizontal direction of the image display area W; and a plurality of data lines 35 are arranged in the vertical directions of the image display area W. In addition, TFTs (not shown) which serve as pixel switching elements are arranged near the intersections of the scanning lines 34 and the data lines 35. The pixel electrodes 33 are electrically connected to the scanning lines 33 and the data lines 35 via the TFTs.

Each formation area of the pixel electrodes 33 constitutes a subpixel. Each subpixel corresponds to one of color element, such as red, green, or blue. The whole image display area W is formed by arranging the subpixels in the horizontal and vertical directions. Although not shown in the drawings, a plurality of color filters are arranged as stripes in the image display area W. Each color filter has a red, green, or blue colors, and corresponds to any one column of subpixels arranged in the vertical direction. The color filters of red, green, and blue are arranged so as to alternate on the subpixel level. One pixel (panel pixel) is constituted by three subpixels corresponding to three color filters of red, green, and blue.

In the peripheral portion of the image display area W, a peripheral driving circuit is provided, which includes a scanning line driving circuit 31, a data line driving circuit 32, and a sampling circuit 38. These circuits may be integrally formed on the substrate of the pixel electrodes 33 or may be separately provided as driving ICs.

Between the data line driving circuit 32 and the sampling circuit 38, three image signal lines 37 are provided for supplying the image data components Dr, Dg, and Db. Each of the three image signal lines 37 corresponds to any one of the three-phase-developed, red-, green- and blue-image data components Dr, Dg, and Db.

One end of each data line 35 is electrically connected to a corresponding sampling switch 36. Each sampling switch 36 is electrically connected to any one of three image signal lines 37 for supplying three-phase image data components Dr, Dg, and Db. The sampling switches 36 are arranged in the horizontal direction, and the sampling circuit 38 is formed by the sampling switches 36.

The scanning line driving circuit 31 receives the Y clock signal CLY, the inverted Y clock signal CLYinv and the Y start pulse DY from the timing control circuit 8 shown in FIG. 2. Upon receiving the Y start pulse DY, the scanning line driving circuit 31 sequentially generates and outputs scanning signals G1, G2, . . . , Gm in synchronization with the Y clock signal CLY and the inverted Y clock signal CLYinv.

The data line driving circuit 32 receives the X clock signal CLX, the inverted X clock signal CLXinv and the X start pulse DX from the timing control circuit 8 shown in FIG. 2. Upon receiving the X start pulse DX, the data line driving circuit 32 sequentially generates and outputs sampling signals S1, S2, . . . , Sn in synchronization with the X clock signal CLX and the inverted X clock signal CLXinv.

The sampling signals are supplied to each pixel (panel pixel) in a set of three (red, green, and blue) subpixels which are arranged adjacently in the horizontal direction. The data line driving circuit 32 sequentially supplies the sampling signals S1, S2, . . . , Sn to the sampling switches 36 on a pixel-by-pixel basis. The sampling switches 36 are sequentially turned ON in accordance with the sampling signals. The image data components Dr, Dg, and Db are sequentially supplied to the data lines 35 on a pixel-by-pixel basis via the turned ON sampling switches 36.

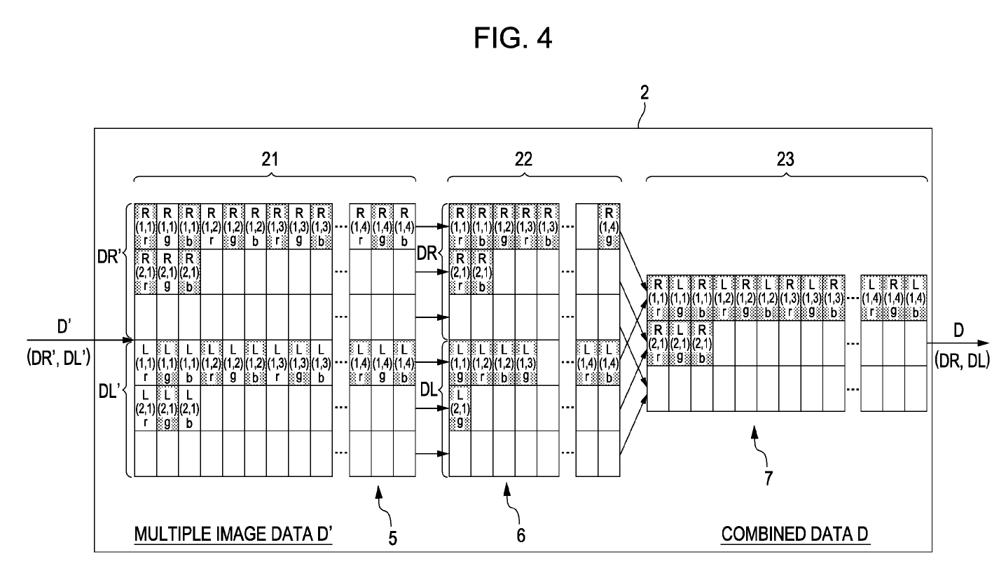

Next, an image processing method of the image data combining circuit 2 will be described with reference to FIG. 4. First, the read-in control circuit 21 reads in the multiple image data D′. The read-in control circuit 21 filters out portions of the right-eye image data DR′ and the left-eye image data DL′ included in the multiple image data D′ and produces new right-eye image data DR and new left-eye image data DL, thereby supplying the new image data DR and DL to the memory 22.

The multiple image data D′ includes the right-eye image data DR′ which corresponds to one screen, as represented by R(1, 1), R(1, 2), . . . and the left-eye image data DL′ which corresponds to second screen as represented by L(1, 1), L(1, 2), . . . In FIG. 4, numeral 5 represents the arrangement of the multiple image data D′ corresponding to single screen supplied from an external source; and numeral 6 represents the arrangement of the multiple image data D′ in a storage area of the memory 22. Numeral 7 represents the arrangement of the image data (combined data) D corresponding to single screen obtained by selecting and rearranging a portion of the multiple image data D′. The combined data D includes the right-eye image data DR obtained by extracting a portion of the right-eye image data DR′ and the left-eye image data DL obtained by extracting a portion of the left-eye image data DL′. These image data DR and DL are rearranged on the subpixel level and are output as the image data components Dr, Dg, and Db of the subpixels of red, green, and blue (see FIG. 2).

In the arrangement diagrams 5 and 7, each rectangular area represents image data of a subpixel. The characters on the upper two lines in each rectangular area represent the type (right-eye or left-eye image) of the image data and the coordinates on the screen W of the pixel including the subpixel. For example, if the upper portion of the rectangular area of the image data is indicated by “R(n, k)” (wherein, n and k are integers), the image data is the right-eye image data of a pixel arranged at the n-th row and k-th column on the screen W. The character on the bottom line in each rectangular area represents the color information of the subpixel. The characters “r,” “g,” and “b” represent color information of red, green, and blue, respectively. For example, if the bottom line in the rectangular area of the image data is indicated by “m” (wherein, m is r, g or b), the image data is the image data of a subpixel corresponding to a color filter of m color. Hereinafter, the image data of the subpixel will be simply denoted as “R(n, k)m” (wherein, n and k are integers; and m is r, g or b).

First, in the read-in control circuit 21, for the right-eye image data DR′, the image data R(1, 1)g of the red subpixel is filtered out from the image data of the pixel at coordinates (1, 1), and the image data R(1, 1)r and R(1, 1)b of the red and blue subpixels, respectively, are stored in the memory 22. Similarly, the image data R(1, 2)r and R(1, 2)b of the red and blue subpixels, respectively, are filtered out from the image data of the pixel at coordinates (1, 2), and the image data R(1, 2)g of the green subpixel is stored in the memory 22. The image data R (1, 3)g of the green subpixel is filtered out from the image data of the pixel at coordinates (1, 3), and the image data R(1, 3)r and R(1, 3)b of the red and blue subpixels, respectively, are stored in the memory 22.

Using this method, the image data of odd-numbered pixels having green colored information are filtered out, while the image data having color information of red and blue are stored in the memory 22. At even-numbered pixels, the image data having color information of red and blue are filtered out, and the image data having green color information are stored in the memory 22. As a result, new right-eye image data DR having an information amount half the size than that of the right-eye image data DR′ are stored in the memory 22. The new right-eye image data DR is obtained by storing a portion of the original right-eye image data DR′ having predetermined color information while filtering out the remaining portion of the original right-eye image data DR′. Thus, the information amount of the image data DR is reduced by 50 percent as a whole.

After completing the image processing operation for the right-eye image data DR′, the image processing operation for the left-eye image data DL′ is performed. In the read-in control circuit 21, the left-eye image data L(1, 1)r and L(1, 1)b of the red and blue subpixels are filtered out from the image data of the pixel at coordinates (1, 1), and the image data L(1, 1)g of the green subpixel is stored in the memory 22. The image data L(1, 2)g of the green subpixel is filtered out from the image data of the pixel at coordinates (1, 2), and the image data L(1, 2)r and L(1, 2)b of the red and blue subpixels is stored in the memory 22. The image data L(1, 3)r and L(1, 3)b of the red and blue subpixels are filtered out from the image data of the pixel at coordinates (1, 3), and the image data L(1, 3)g of the green subpixel is stored in the memory 22.

Thus, at the image data of odd-numbered pixels, the image data having color information of red and blue is filtered out, while the image data having color information of green are stored in the memory 22. At the even-numbered pixels the image data having color information of green is filtered out, while the image data having color information of red and blue is stored in the memory 22. As a result, new left-eye image data DL of about half the size of the left-eye image data DL′ is stored in the memory 22. The new left-eye image data DL are obtained by storing a portion of the original left-eye image data DL′ of predetermined color information while filtering out the remaining portion of the original left-eye image data DR′. Thus, the information amount of the image data DL is reduced by 50 percent.

After the image processing operation, the read-out control circuit 23 reads out the right-eye image data DR and the left-eye image data DL from the memory 22 according to a predetermined rule. The red, green, and blue subpixels included in the pixel at coordinates (1, 1) are supplied with the image data R(1, 1)r, L(1, 1)g, and R(1, 1)b, respectively. The red, green, and blue subpixels included in the pixel at coordinates (1, 2) are supplied with the image data L(1, 2)r, R(1, 2)g, and L(1, 2)b, respectively. In this way, the red, green, and blue subpixels included in the odd-numbered pixels are supplied with the red image data of the right-eye image, the green image data of the left-eye image, and the blue image data of the right-eye image, respectively. The red, green, and blue subpixels included in the even-numbered pixels are supplied with the red image data of the left-eye image, the green image data of the right-eye image, and the blue image data of the left-eye image, respectively. As a result, new image data (combined data) D are produced by combining the right-eye image data DR and the left-eye image data DL with each other.

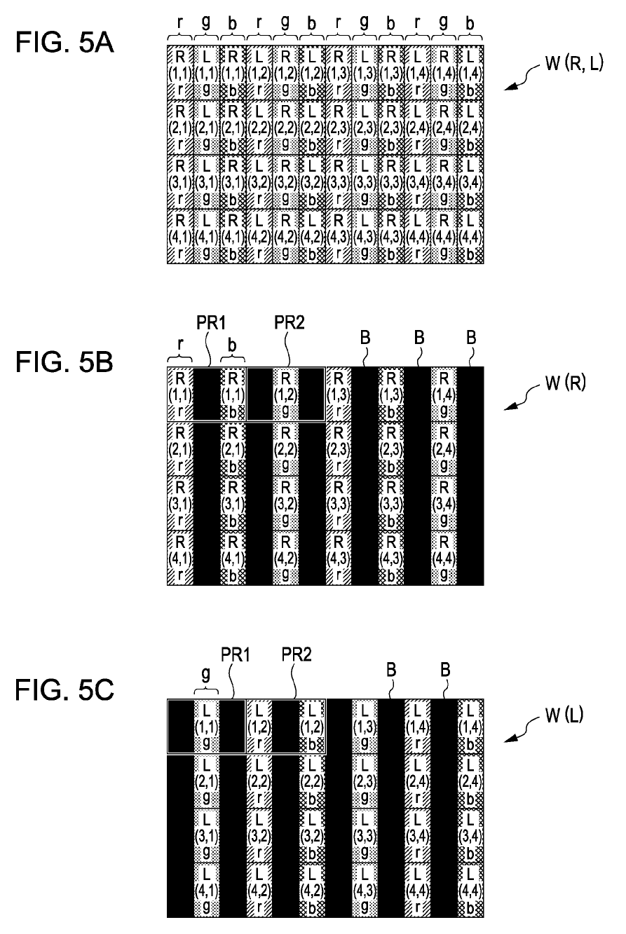

FIGS. 5A and 5C show plan views of a part of an image of the combined data D displayed on the screen W. FIG. 5A shows a combined image of the left-eye image L and the right-eye image R, FIG. 5B shows the right-eye image R as observed through the parallax barrier B, and FIG. 5C shows the left-eye image L as observed through the parallax barrier B. In the drawing, the characters “r,” “g” and “b” represent subpixels associated with the color filters of red, green, and blue, respectively.

As shown in FIG. 5A, the subpixels for displaying the right-eye image R and the subpixels for displaying the left-eye image L are arranged so as to alternate in the horizontal direction. As viewed from the vertical direction, a plurality of subpixels for displaying the right-eye image R and a plurality of subpixels for displaying the left-eye image L are alternately arranged into columns of subpixels. That is, the plurality of subpixels for displaying images R and L are arranged in the arrangement direction of the color filters into vertical stripes.

In FIG. 5B, a set of one or two subpixels represented by the same coordinates (n, k) constitutes one display pixel PR1 or PR2 for the right-eye image R. Thus, the display pixel PR1 disposed in the upper left side of the drawing is composed of two (red and blue) subpixels among three adjacent subpixels. The display pixel PR2 disposed next to the display pixel PR1 is composed of one (green) subpixel from among three subpixels that are arranged adjacently in the horizontal direction. Each display pixel PR1 and PR2 is the minimum display unit for displaying the post-combined right-eye image R, and is different from the pixel (panel pixel) of the screen W. That is, each display pixel PR1 and PR2 is different from the pixel composed of a set of three (red, green, and blue) adjacent subpixels. A plurality of display pixels PR1 and PR2 for the right eye (right-eye display pixel) are arranged in the horizontal and vertical directions on the screen W. The plurality of right-eye display pixels PR1 and PR2 form the entire right-eye image R.

In FIG. 5C, a set of one or two subpixels represented by the same coordinates (n, k) constitutes one display pixel PL1 or PL2 for the left-eye image L. Thus, display pixel PL1 is composed of one (green) subpixel among three adjacent subpixels in the horizontal direction. PL2 is composed of two (red and blue) subpixels of the three adjacent subpixels. Each display pixel PL1 and PL2 is a minimum display unit for displaying a post-combined left-eye image L, and are different from the pixel (panel pixel) of the screen W. That is, each display pixel PL1 and PL2 is different from the pixel composed of a set of three (red, green, and blue) adjacent subpixels in the horizontal direction. On the screen W, a plurality of display pixels PL1 and PL2 for the left eye (left-eye display pixel) are arranged in the horizontal and vertical directions. The plurality of left-eye display pixels PL1 and PL2 form the whole left-eye image L.

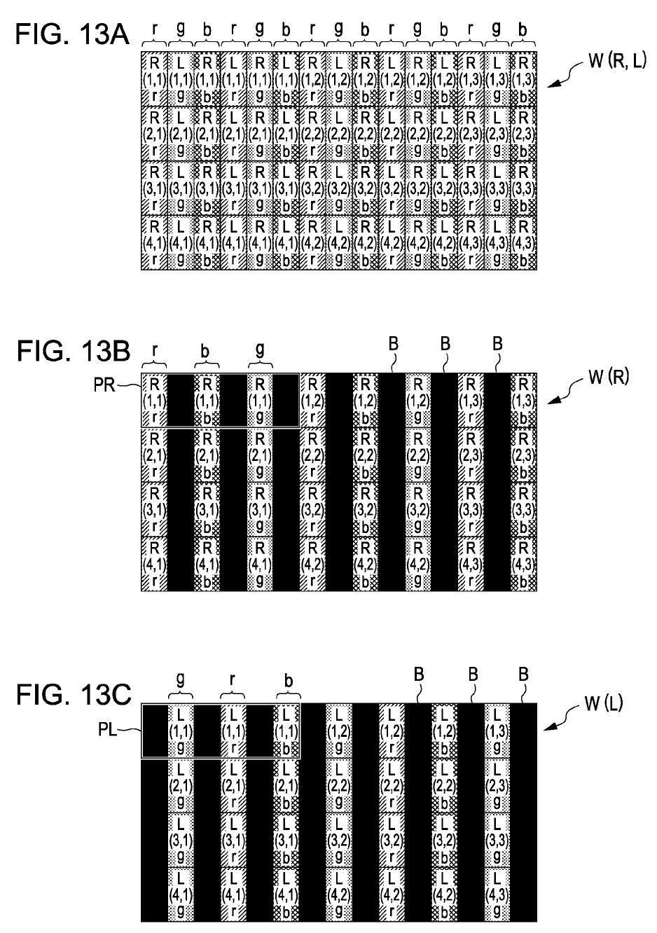

In the present embodiment, the display pixel PR1 is constructed such that the green subpixel is omitted from the display pixel PR shown in FIG. 13B. For this reason, the display pixel is purple. Meanwhile, the display pixel PR2 is constructed such that the red and blue subpixels are omitted from the display pixel PR shown in FIG. 13B. For this reason, the display pixel is colored green. However, since the display pixels PR1 and PR2 are adjacent to each other, the colors are compensated among the display pixels. Thus, it is possible to negate the color difference in a resulting image as a whole. Moreover, since a portion of color information is omitted from the individual display pixels PR1 and PR2, it is difficult to obtain absolutely accurate color reproducibility. Since in many cases similar images are displayed by the adjacent display pixels, color compensation is realized between the adjacent display pixels. Thus, it is possible to obtain relatively accurate color reproducibility. The size of the individual display pixels PR1 and PR2 is equal to that of the pixels (panel pixels) required for displaying the two-dimensional image. Thus, the resolution is not reduced, even when displaying a fine image. Accordingly, the right-eye image R formed by the display pixels PR1 and PR2 has high color reproducibility and a smooth border.

The above statements can be similarly applied to the case of the left-eye image L shown in FIG. 5C. The display pixel PL1 is constructed such that the red and blue subpixels are omitted from the display pixel PL shown in FIG. 13C. Thus, the display pixel is green. Meanwhile, the display pixel PL2 is constructed such that the green subpixel is omitted from the display pixel PL shown in FIG. 13C, making the display pixel purple. However, since the display pixels PL1 and PL2 are adjacent to each other, color compensation is realized between the display pixels. Thus, it is possible to negate the color difference in a resulting image as a whole. Moreover, since a portion of color information is omitted from the individual display pixels PL1 and PL2, it is difficult to obtain absolutely accurate color reproducibility. Since in many cases similar images are displayed by the adjacent display pixels, color compensation is realized between the adjacent display pixels. Thus, it is possible to obtain relatively accurate color reproducibility. The size of the individual display pixels PL1 and PL2 is equal to that of the pixels (panel pixels) required for displaying the two-dimensional image. Thus, the resolution is not reduced even at the time of displaying a fine image. Accordingly, the left-eye image L formed by the display pixels PL1 and PL2 has high color reproducibility and a smooth border.

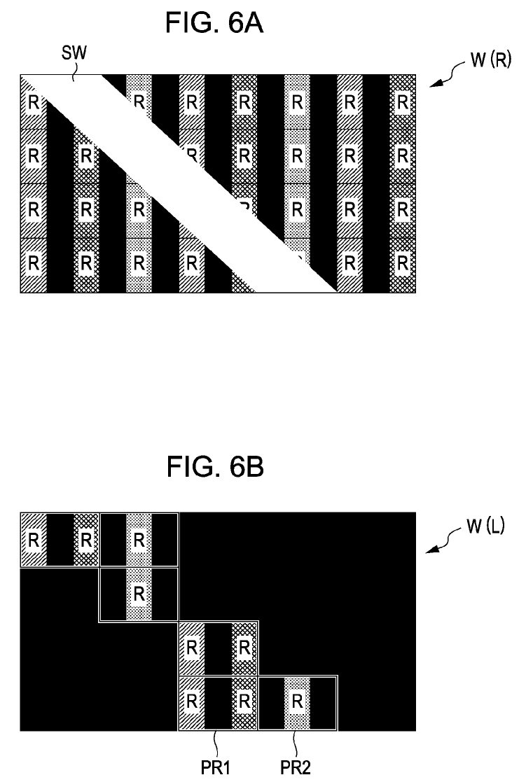

FIGS. 6A and 6B show the case where a white bright line SW is displayed on the screen W. As shown in FIG. 6A, when the bright line SW is displayed on the right-eye image R, it is necessary to illuminate the display pixels PR1 and PR2 overlapped by the bright line SW (FIG. 6B). In this case, since the size of the display pixels PR1 and PR2 is equal to that of the pixels (panel pixels) required for displaying the two-dimensional image, the width of the bright line SW is not increased in the horizontal direction. Accordingly, it is possible to reproduce the original shape of the bright line SW in a relatively accurate manner.

According to the display device 1 of the present embodiment, since the size of the display pixels PR1, PR2, PL1, and PL2 for displaying a combined image is equal to that of the pixels (panel pixels) required for displaying the two-dimensional image, it is possible to display an image with a high resolution. In this case, although it is difficult to obtain absolutely accurate color reproducibility in the individual display pixels, the displayed colors are different from each other between the adjacent display pixels (between display pixels PR1 and PR2 or between display pixels PL1 and PL2). Therefore, color compensation is realized between the adjacent display pixels. Thus, it is possible to obtain accurate color reproducibility as a whole.

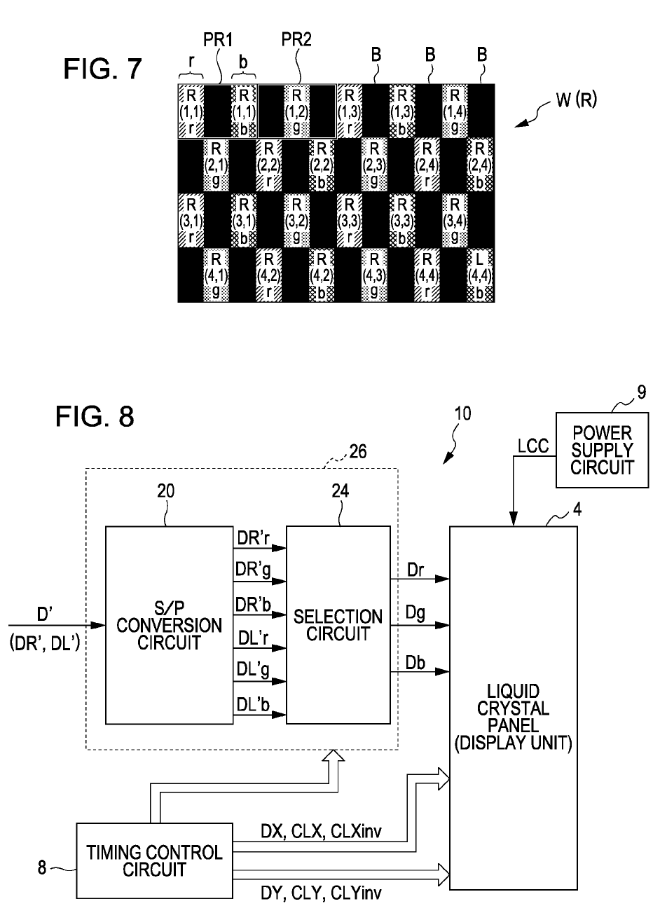

In the present embodiment, the stripe barrier method is used wherein the parallax barrier B is disposed in the vertical direction. However, the invention may be applied to the oblique barrier method (step barrier method) wherein the parallax barrier B is obliquely arranged in the horizontal direction. FIG. 7 is a plan view of the screen W when the step barrier method is used, corresponding to FIG. 5A, which shows the right-eye image R as observed through the parallax barrier B. In the drawing, the display pixels PR1 at coordinates (2, 2) have color information of red and blue; and four adjacent display pixels surrounding the display pixel PR1, i.e., the display pixels at coordinates (1, 2), (2, 1), (3, 2), and (2, 3) have color information of green. Therefore, in the case of the step barrier method, unlike the stripe barrier method, color compensation is realized between the display pixels arranged adjacent to each other in both the horizontal and vertical directions. Accordingly, it is possible to obtain a high-quality image without deteriorating the color reproducibility.

The present embodiment of the invention relates to a stereoscopic display device for displaying a stereoscopic image. However, the invention may be applied to a multi-viewpoint display device for presenting a multi-viewpoint image to a plurality of observers. In the case of the stereoscopic display device, the right-eye image data DR′ and the left-eye image data DL′ are prepared as the image data for display, and the right-eye image R and the left-eye image L are spatially separated using the image separating unit (parallax barrier, for example). In the case of the multi-viewpoint display device, multi-viewpoint image data are prepared as the image data for display, and images of different viewpoints are spatially separated using the image separating unit (parallax barrier, for example). For example, in the case of a display device for an on-vehicle navigation system, an image of a first viewpoint (driver's seat side) and an image of a second viewpoint (passenger's seat side) may be prepared as a navigation image and a television image, respectively. The navigation image and the television image may presented to the corresponding observers (driver and passenger) using the image separating unit. In the case of the stereoscopic display device, the arrangement relationship between the panel pixel and the apertures of the parallax barrier are determined on the basis of the position of the right and left eyes. In the case of the multi-viewpoint display device, the arrangement relationship between the panel pixel and the apertures of the parallax barrier is determined on the basis of the position of the observers.

In the present embodiment, a liquid crystal panel is used as the display unit 3. However, other display panels may be used as the display unit. Examples include a non-emission-type panel such as a liquid crystal panel or an electrophoresis panel and a self-emission-type panels such as an electroluminescence (EL) panels. Moreover, instead of the parallax barrier as an image separating unit, lenticular lenses may be used as the image separating unit.

In the present embodiment, one display pixel is composed of a pixel in which a portion of color information is omitted. In the case of displaying one white line in the vertical direction, a purple or green line may flicker on the screen. In this case, it is desirable to display the white line by simultaneously illuminating adjacent display pixels.

### Second Embodiment

FIG. 8 is a block diagram showing the construction of a display device 10 in accordance with a second embodiment of the invention. The display device 10 includes a liquid crystal panel 4 serving as the display unit, an image data supply circuit 26, a timing control circuit 8, and a power supply circuit 9. The same constituent elements as those of the display device 1 of the first embodiment will be referenced by the same reference numerals, and the detailed descriptions thereof will be omitted.

The image data supply circuit 26 includes an S/P conversion circuit 20 and a selection circuit 24. The selection circuit 24 selects portions of six image data components DR′r, DR′g, DR′b, DL′r, DL′g and DL′b which were phase-developed by the S/P conversion circuit 20 and supplies them to the liquid crystal panel 4. On the liquid crystal panel 4, a combined image is displayed that is formed by the image data components Dr, Dg, and Db selected by the selection circuit 24. The image data components Dr, Dg, and Db respectively are image data components of red, green, and blue for the combined image.

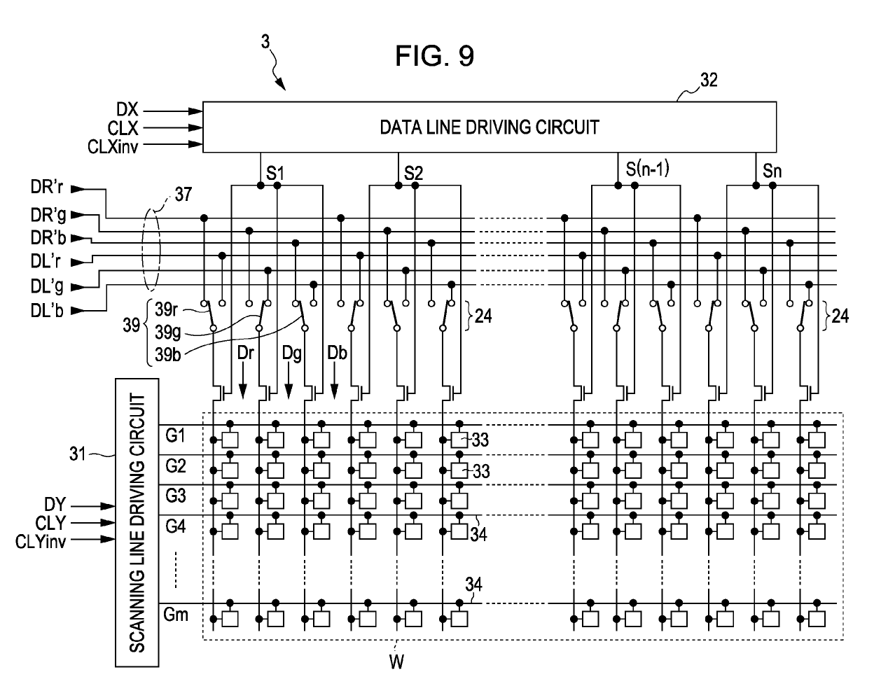

FIG. 9 is a block diagram showing the electrical construction of the liquid crystal panel 4 and a peripheral driving circuit of the display device 1. The liquid crystal panel 4 is provided with an image display area (screen) W for displaying the image data components Dr, Dg, and Db. In the image display area W, a plurality of pixel electrodes 33 are aligned in a matrix in the horizontal and vertical directions. At the borders of the pixel electrodes 33, a plurality of scanning lines 34 are arranged in the horizontal direction of the image display area W, and a plurality of data lines 35 are arranged in the vertical direction of the image display area W. In addition, TFTs (not shown) serving as pixel switching elements are arranged near the intersections of the scanning lines 34 and the data lines 35. The pixel electrodes 33 are electrically connected to the scanning lines 33 and the data lines 35 via the TFTs.

Each formation area of the pixel electrodes 33 constitutes a subpixel. Each subpixel corresponds to any one of color elements red, green, and blue. The whole image display area W is formed by the subpixels arranged in the horizontal and vertical direction. Although not shown in the drawings, a plurality of color filters are arranged as stripes on the image display area W. Each color filter has any one of red, green, and blue colors, which correspond columns of subpixels arranged in the vertical direction. The color filters of red, green, and blue are alternately arranged on the subpixel level. One pixel (panel pixel) is comprised of three subpixels corresponding to three color filters of red, green, and blue.

In the peripheral portion of the image display area W, a peripheral driving circuit is provided which includes a scanning line driving circuit 31, a data line driving circuit 32, and a sampling circuit 38. These circuits may be integrally formed on the substrate of the pixel electrodes 33 and may be separately provided as driving ICs.

Between the data line driving circuit 32 and the sampling circuit 38, six image signal lines 37 are provided for supplying the image data components DR′r, DR′g, DR′b, DL′r, DL′g, and DL′b. Each of the six image signal lines 37 corresponds to one of the right-eye red-image data component DR′r, the right-eye green-image data component DR′g, the right-eye blue-image data component DR′b, the left-eye red-image data component DL′r, the left-eye green-image data component DL′g, and the left-eye blue-image data component DR′b, wherein the image data components are developed into six phases.

One end of each data line 35 is electrically connected to a corresponding one of the sampling switches 36. Each sampling switch 36 corresponds to two image signal lines for supplying the right-eye image data and the left-eye image data. Between the sampling switches 36 and the image signal lines 37, selection switching elements 39 (39r, 39g, and 39b) are provided for selecting one of two image signal lines 37.

The sampling switches 36 connected to the data lines 35 for supplying the red-image data components are connected to the image signal line 37 for supplying the right-eye red-image data component DR′r and to the image signal line 37 for supplying the left-eye red-image data component DL′r. A switching element 39r (for red) is provided between the two data signal lines 37 and one sampling switch 36 for selecting one of the image signal lines 37.

The sampling switches 36 connected to the data lines 35 for supplying the green-image data components are connected to the image signal line 37 for supplying the right-eye green-image data component DR′g and to the image signal line 37 for supplying the left-eye green-image data component DL′g. A switching element 39g (for green) is provided between the two data signal lines 37 and one sampling switch 36 for selecting one of the image signal lines 37.

The sampling switches 36 connected to the data lines 35 for supplying the blue-image data components are connected to the image signal line 37 for supplying the right-eye blue-image data component DR′b and to the image signal line 37 for supplying the left-eye blue-image data component DL′b. A blue switching element 39b (for blue) is provided between the two data signal lines 37 and one sampling switch 36 for selecting one of the image signal lines 37.

The selection switching elements 39 are arranged in the horizontal direction, and the selection circuit 24 is formed by the selection switching elements 39. The selection circuit 24 selects the image data of the subpixels selected as the display pixel of the right-eye image and the image data of the subpixels selected as the display pixel of the left-eye image, respectively from pre-combined image data DR′r, DR′g, and DR′b for the right-eye image supplied from an external source and pre-combined image data DL′r, DL′g, DL′b for the left-eye image supplied from the external source. The selection circuit 24 then outputs the image data for the right-eye and left-eye images to a corresponding one of the subpixels.

The scanning line driving circuit 31 receives the Y clock signal CLY, the inverted Y clock signal CLYinv, and the Y start pulse DY from the timing control circuit 8 shown in FIG. 8. Upon receiving the Y start pulse DY, the scanning line driving circuit 31 sequentially generates and outputs scanning signals G1, G2, . . . , Gm in synchronization with the Y clock signal CLY and the inverted Y clock signal CLYinv.

The data line driving circuit 32 receives the X clock signal CLX, the inverted X clock signal CLXinv, and the X start pulse DX from the timing control circuit 8 shown in FIG. 8. Upon receiving the X start pulse DX, the data line driving circuit 32 sequentially generates and outputs sampling signals S1, S2, . . . , Sn in synchronization with the X clock signal CLX and the inverted X clock signal CLXinv.

The sampling signals are supplied to each pixel (each panel pixel) as a set of three (red, green, and blue) subpixels adjacently arranged in the horizontal direction. The data line driving circuit 32 sequentially supplies the sampling signals S1, S2, . . . , Sn to the sampling switches 36 on a pixel-by-pixel basis. The sampling switches 36 are sequentially turned ON in accordance with the sampling signals. The image data components Dr, Dg, and Db are sequentially supplied to the data lines 35 on a pixel-by-pixel basis via the turned ON sampling switches 36.

In the selection circuit 24, in synchronization with turning-ONs of the sampling switches 36, the selection switching element 39 selects one of two image signal lines 37. As viewed from the horizontal direction, the selection switching element 39 alternately selects the right-eye image data and the left-eye image data on a column-by-column basis (on a subpixel-by-subpixel basis). For this reason, the image data not selected by the selection switching element 39 is filtered out, and the information amount is reduced by 50 percent.

Among the right-eye and left-eye image data corresponding to one pixel, the right-eye and left-eye image data selected by the selection switching elements 39 are output to the area of the liquid crystal panel corresponding to one pixel (one panel pixel). The size of the display pixel, which is a minimum display unit of the right-eye and left-eye image, becomes equal to that of one pixel (one panel pixel) of the liquid crystal panel 4. Since the color information items for display are different from each other between adjacent display pixels, color compensation is realized between the adjacent display pixels. Thus, it is possible to obtain relatively accurate color reproducibility.

As described above, the same combined image is obtained as that obtained by the display device 1 of the first embodiment. In the combined image, the size of the display pixel, which is a minimum display unit of the right-eye image and the left-eye image, is equal to that of one pixel (one panel pixel) of the liquid crystal panel 4. Accordingly, it is possible to display an image having a higher resolution and a smoother border than display devices known in the art. Moreover, since the displayed colors are different from each other between adjacent display pixels, color compensation is realized between the adjacent display pixels. Thus, it is possible to obtain relatively accurate color reproducibility. Moreover, unlike the display device 1 of the first embodiment, since the memory is not required, it is possible to provide a display device at low cost.

### Electronic Apparatus

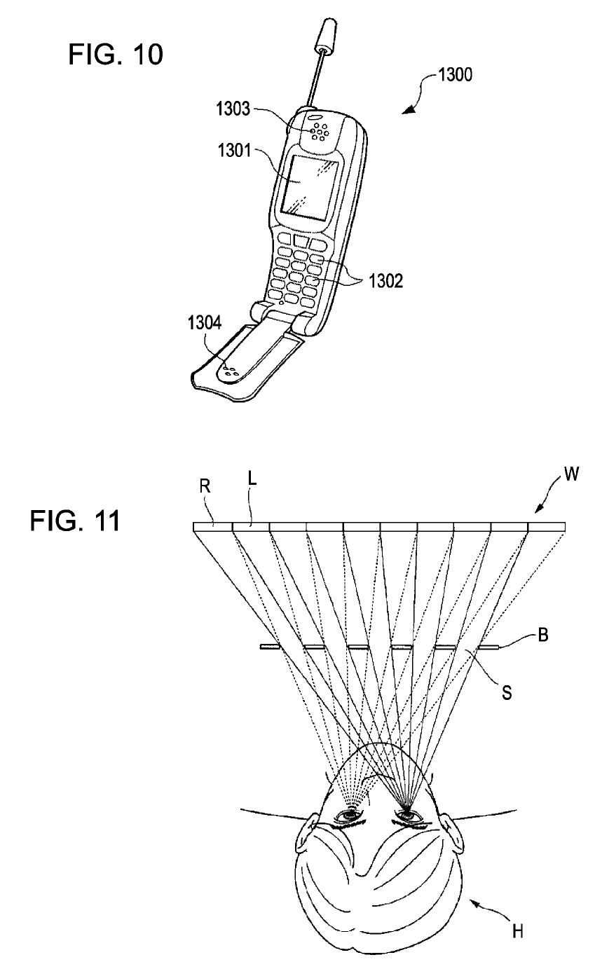

FIG. 10 is a perspective view showing an example of the electronic apparatus of the invention. The cellular phone 1300 includes a plurality of operation buttons 1302, an earpiece 1303, a mouthpiece 1304, and a display unit 1301 to which the display device of the invention is applied. Other electronic apparatuses which the display device of the above embodiments may be applied include electronic books, personal computers, a digital still cameras, a liquid crystal TVs, view-finder-types (or monitor-direct-view-type) video tape recorders, car navigation devices, pagers, electronic organizers, calculators, word processors, workstations, video phones, POS terminals, an apparatuses equipped with a touch panel other than the cellular phone. Accordingly, it is possible to provide an electronic apparatus capable of displaying an image having a clear and smooth border.

Although the exemplary embodiments of the invention have been described with reference to the accompanying drawings, it should be understood that the invention is not limited to such embodiments. Various shapes or combinations of respective constituent elements illustrated in the above-described embodiments are merely examples, and various changes may be made depending on design requirements or the like without departing from the spirit or scope of the invention.

What is claimed is:

1. A display device for displaying a first and second image on a display unit, the display device comprising:
pixels including a plurality of subpixels of different colors;
a display unit capable of arranging the pixels in the horizontal and vertical direction;
an image data combining circuit capable of combining image data for a first image and image data for a second image; and
an image separation member capable of spatially separating the display of the first image and the second image on the display unit,
wherein the first image comprises display pixels comprised of one or more subpixels selected from the plurality of subpixels included in one pixel, and
wherein the second image comprises display pixels comprised of one or more subpixels other than the one or more subpixels selected for the first image.

2. The display device according to claim 1, wherein adjacent subpixels in a display pixel are of different colors.

3. The display device according to claim 1, wherein, the total of the number of subpixels selected for a display pixel of the first image and the number of subpixels selected as the display pixel of the second image is equal to the number of subpixels included in the one pixel.

4. The display device according to claim 1, wherein the image data combining circuit comprises:
a read-in control circuit capable of selectively storing image data of the selected subpixels of the first image and second image from pre-combined image data for the first image and second image supplied from an external source into a memory; and
a read-out control circuit capable of outputting the image data stored in the memory to corresponding subpixels of a display pixel via image signal lines.

5. The display device according to claim 1, wherein the image data combining circuit includes:
a selection circuit capable of selecting image data of the selected subpixels of the first and second image from pre-combined image data for the first and second image which are supplied from the external source, and outputting the image data for the first and second images to corresponding subpixels.

6. The display device according to claim 5,
wherein the selection circuit includes a plurality of selection switching elements arranged in a horizontal direction,
wherein the plurality of selection switching elements are connected to a plurality of subpixels arranged in the horizontal and vertical direction, and
wherein each selection switching element is connected to two image signal lines for supplying the pre-combined image data for the first and second images to a corresponding subpixels which are electrically connected to the selection switching element.

7. The display device according to claim 6, wherein the selection switching elements corresponding to the subpixels of a common color are configured to select the image data so that the image data of adjacent subpixels represent different images.

8. The display device according to claim 1, wherein the selected subpixels for the first and second image are arranged so as to alternate in at least one of the horizontal and vertical direction.

9. The display device according to claim 8, wherein the selected subpixels of the first and second image are arranged so as to alternate in both the horizontal and vertical direction.

10. The display device according to claim 1, wherein the first image is an image for the right eye, and the second image is an image for the left eye.

11. The display device according to claim 1, wherein the first image is a first-viewpoint image observed from a first viewpoint, and the second image is a second-viewpoint image observed from a second viewpoint.

12. An image processing method in which a first image and a second image comprised of pixels are combined and displayed on one screen, the method comprising:
constructing a display pixel of the first image from one or more subpixels selected from a plurality of subpixels included in one pixel of the first image; and
constructing a display pixel of the second image from one or more subpixels selected from a plurality of subpixels included in the one pixel of the second image.

13. An electronic apparatus comprising the display device according to claim 1.

14. A method of combining a first image and a second image for display on one screen, the method comprising:
receiving first and second image comprised of pixels including subpixels;
constructing a display pixel by combining selected subpixels from a plurality of subpixels of the first image and selected subpixels from a plurality of subpixels of the second image; and
displaying a plurality of display pixels on one screen;
wherein selected subpixels of the first and second image in the display pixels are arranged so as to alternate in both the horizontal and vertical direction.

15. The method according to claim 15, wherein the first image is an image for the right eye, and the second image is an image for the left eye.

16. The method according to claim 15, wherein the first image is a first-viewpoint image observed from a first viewpoint, and the second image is a second-viewpoint image observed from a second viewpoint.
